(19) United States
(12) Patent Application Publication
(10) Pub. No.: US 2009/0314053 A1
(43) Pub. Date: Dec. 24, 2009

(54) Device for calibration of a humidity sensor and a sensor arrangement with a humidity sensor which may be calibrated

(76) Inventors: Martin Rombach, Lenzkirch (DE); Markus Langenbacher, Lenzkirch (DE)

Correspondence Address: MUIRHEAD AND SATURNELLI, LLC, 200 FRIBERG PARKWAY, SUITE 1001, WESTBOROUGH, MA, 01581, US

(21) Appl. No.: 11/991,341

(22) PCT Filed: Aug. 24, 2006
(86) PCT No.: PCT/EP2006/008295

§ 371 Date: Mar. 23, 2009

(30) Foreign Application Priority Data
Aug. 29, 2005 (DE) 202005013613.1

(51) Int. Cl. G01D 18/00

(52) U.S. Cl. 73/1.06

(57) ABSTRACT

A device for calibration of a humidity sensor with a measuring chamber includes a first gas connector for connection to a pressurizing unit and a second gas connection for connection to a further gas chamber. The first and/or the second gas connector may have a flow resistance which may be adjusted to two different fixed values.

The present invention relates to a device for calibrating a humidity sensor having a measuring chamber, which has a first gas connection for connecting to a pressurizable unit and a second gas connection for connecting to another gas space.

The relative humidity in open or closed gas volumes, i.e., the amount of humidity dissolved in a particular gas relative to the maximal amount of humidity dissolvable in the gas at a given temperature, is measured with the help of humidity sensors.

Such measurements are familiar to the average consumer, e.g., as measurements of relative humidity for determination of climate conditions, but they are also commonly used in an industrial environment, e.g., in determination of relative humidity in pressurized gas containers. Humidity sensors are often extremely subject to physical and chemical influences and may therefore significantly alter their response characteristic with respect to an initial calibration. Recalibration is therefore necessary at certain intervals.

Calibration of a humidity sensor is known from the related art (DE 3936138 A1, U.S. Pat. No. 6,073,480), in that a first humidity measurement is performed at a first temperature and then a second humidity measurement is performed at a second temperature while the gas pressure remains the same in both measurements. A correction value for the humidity measurement may be calculated from the measured temperature and humidity values because the mathematical relationship between temperature and actual relative humidity is known.

However, to apply this technology, on the one hand, temperature sensors must be provided in the area of the humidity sensors but, on the other hand, heating or cooling elements must also be provided. Furthermore, such a calibration requires time to adjust the particular measurement temperatures.

The object of the present invention in comparison with the related art is to create a device for calibrating a humidity sensor and a sensor system having a calibratable humidity sensor of the type defined in the introduction with which the calibration operation is simplified and the fewest possible auxiliary means are required to perform the calibration.

This object is achieved according to the present invention by the fact that the first gas connection and/or the second gas connection has/have a flow resistance which is adjustable to two different fixed values. From the related art (DE 102 036 37 B4), a calibration method is known, in which a humidity value U1, U2 is detected at a first pressure P1 and at a second pressure P2, which differs from the first pressure under otherwise identical conditions, at least the ratio of first pressure value P1 and second pressure value P2 being known and the correction value for the humidity sensor being determined from the ratio of the pressure values and the measured humidity values.

According to the related art, the different pressure values are measured and assigned to the humidity values which are also measured. To this end, pressure sensors are required and a calibration operation necessitates detection of the corresponding measured values and further processing thereof. According to the present invention, this complexity is reduced by defining the ratio of pressures in the measuring chamber of the two measurements through the choice in setting the flow resistances and then determining and storing these values. Only the humidity values are measured and entered as variables into the calculation of the correction value.

If the humidity value is measured at two different pressures, while the temperature and other ambient conditions are kept constant and the same absolute quantity of humidity remains dissolved in the gas, then the value of the relative humidity will change between the two measurements. From the ratio of the two pressure values, it is possible to determine the ratio of the two humidity values actually prevailing to the relative humidity of the gas. If the ratio of the pressures and the measured relative gas humidity do not match, the deviation may be used to determine the correction value to be used in the particular humidity measurement. This correction value is then subtracted from or added to the measured value of the relative humidity.

Thus accordingly, the device for calibrating a humidity sensor includes a measuring chamber having gas connections according to the present invention by which two different gas pressure values, whose ratio is known and reproducible, may be set when setting two different flow resistances in the first or second gas connection(s) through the particular pressure gradient in the measuring chamber. Furthermore, an input device by which the measured humidity values of the humidity sensor may be supplied to the calibration device is also provided. A processor unit of the calibration device then determines the correction value from the measured data and outputs this value.

The calibration method is advantageously performed so that correction factor k, which is to be subtracted from a measured humidity value, is determined according to the equation:

k=((P1/P2)*U2−U2)/(P1/P2−1).

With a gas of uniform consistency and a constant temperature, the ratio of the two pressure values at which the measurement is performed will ideally correspond to the ratio of relative humidities actually prevailing:

P1/P2=U1(real)/U2(real).

Since measured humidity values U1, U2 do not match the actual humidity values before calibration, actual humidity value U1 is calculated as U1 (real)=U1−k and U2 (real)=U2−k.

This yields the equation: P1/P2=(U1−k)/(U2−k).

Solving this equation for k yields:

k=((P1/P2)*U2−U1/(P1/P2−1).

This is true under the assumption that k is independent of the value of U. Using-the calibration method according to the present invention, the humidity sensor may thus be calibrated using a pressure sensor without determining directly the actual prevailing humidity. It is necessary only to set a defined known pressure ratio of two pressure values, such that a humidity measurement is performed at each individual pressure value.

In a practical manner, the method for calibrating a humidity sensor is advantageously performed in a pressurizable gas-filled unit in such a way that gas is released or supplied via a valve provided on the unit, and pressure values and humidity values before and after the release/supply of gas are recorded, such that a temperature equalization is awaited before performing the humidity measurement.

Valves for filling a unit with gas or for releasing gas are typically provided anyway on pressurizable gas-filled units. Gas may be either released or supplied through such a valve, and released gas may be stored in an external pressure tank. Humidity measurements are performed before and after releasing and/or supplying gas, but it is necessary to wait for the temperature to equalize after releasing or supplying gas because both humidity measurements must be performed at the same temperature and an increase and/or decrease in temperature is to be expected as a result of the release of gas and/or the increase in pressure.

For calibrating the humidity sensor, the sensor may be operated in a measuring chamber connected to the unit in such a way that the different pressure values do not require a change in pressure in the entire unit but instead only the gas pressure in the partial volume in which the humidity sensor is situated need be adjusted. The calibration may thus be performed by service personnel easily, reliably, and rapidly without any major changes or installations on the pressurizable gas-filled unit.

The invention also relates to a sensor system having a calibratable humidity sensor and a correction device having a memory in which a correction value to be subtracted from the measured humidity value may be stored, so the correction device subtracts the correction value from the detected measured value of the humidity and in particular sends the result to a display device.

The sensor system thus has a correction device by which the humidity value detected by the humidity sensor is corrected by using the correction value after a calibration, so that the humidity value actually prevailing is available as a corrected measured value for output or further processing, e.g., on a control panel.

According to the present invention, the flow resistance of the first and/or second gas connection may be altered by having a first channel with a first flow resistance and a second channel that runs parallel to the first, channel and is closable with a cutoff device. In the opened state of the cutoff device, the second channel bridges the first channel so that the entire flow resistance of the particular gas connection is significantly reduced. In this way, very different flow resistances of the first and/or second gas connection may be implemented by closing and opening the cutoff device.

The flow resistance occurring at the second gas connection is advantageously greater than the flow resistance provided in the second channel. of the first gas connection. In this case, an elevated pressure may build up in the measuring chamber when the second inflow channel is opened, this pressure being between the pressure of the second gas connection on the secondary side and the pressure of the pressurizable unit.

The ratio of the flow resistance at the second gas connection to the flow resistance of the second channel of the first gas connection may be greater than 10:1.

If the flow resistance at the second gas connection is less than the flow resistance of the first channel of the first gas connection but is much greater than the flow resistance of the second channel of the first gas connection, then a particularly great pressure ratio of the two pressure values implementable with the second inflow channel opened or cut off may be implemented.

If the flow resistance of the second gas connection is greater than the flow resistance of the first gas connection, this achieves the result that the flow ratios are relatively independent of the outside pressure acting on the second gas connection on the secondary side because in any case an excess pressure much higher than the outside pressure is built up in the measuring chamber.

The second channel on the first or second gas connection is easily implementable in particular by a gas pipe which bridges the first channel and may be cut off by a ball valve.

The present invention is explained in greater detail below and illustrated on the basis of drawings as an example.

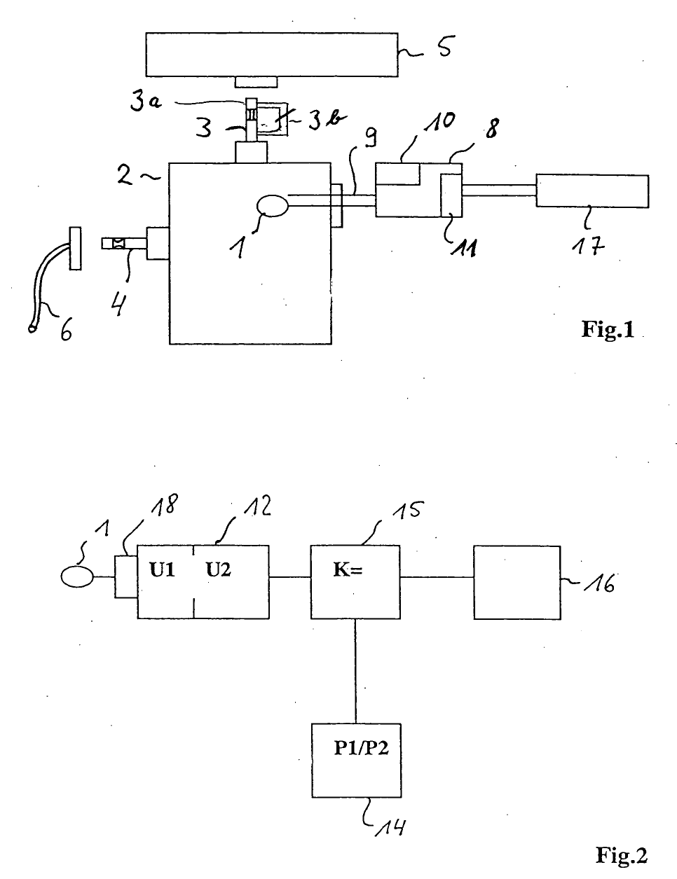

FIG. 1 shows a schematic diagram of a humidity sensor and a device for calibration thereof,

FIG. 2 shows schematically the function of the processor unit for ascertaining the correction value,

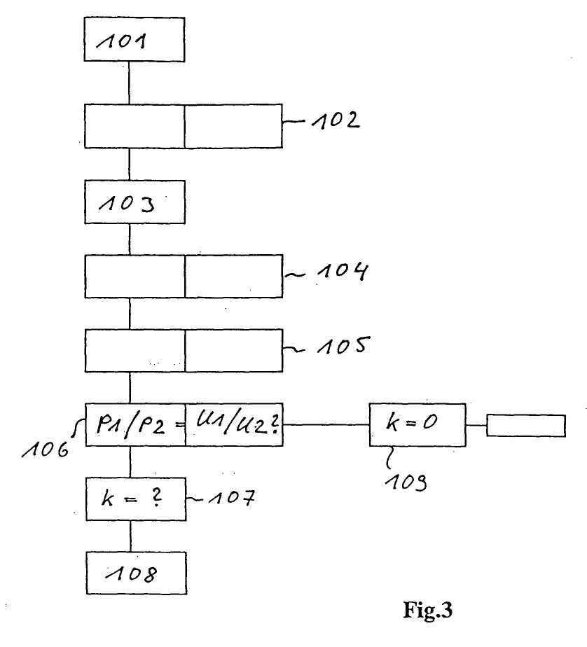

FIG. 3 shows a flow chart of the calibration operation,

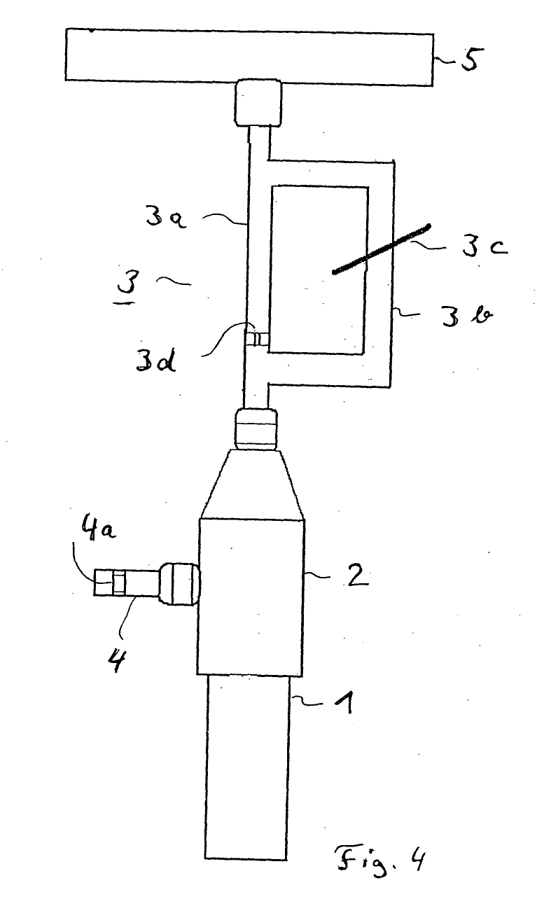

FIG. 4 shows a measuring chamber having gas connections in a detailed diagram.

FIG. 1 first shows a humidity sensor 1 in a gastight measuring chamber 2. Measuring chamber 2 has a first gas connection 3 and a second gas connection 4 by which the measuring chamber may be connected to a gas-filled pressurizable unit 5 on the one hand and to another gas space, optionally via a pressure tube 6, on the other hand.

To measure the gas humidity in pressurizable unit 5, for example, and at the same time calibrate humidity sensor 1, measuring chamber 2 is first connected via first gas connection 3 to pressurizable unit 5, so that gas flows through a first channel 3a into and back out of the measuring chamber through second gas connection 4. At the first pressure value, which is established due to the ratio of the flow resistances, the first humidity value is determined. The flow resistance of the first gas connection is then changed to a second value, by opening a ball valve in a second channel 3b. The result is that a second pressure value is established in the measuring chamber, the second humidity value being measured at this pressure value. Correction device 8 is bridged temporarily in the calibration operation.

The various pressure values may also be adjustable by varying the flow resistance of the second gas connection in a defined manner.

A correction value stored in memory 10 may then be ascertained from the known ratio of the pressure values and the two measured and uncorrected measured humidity values. The correction value stored in the memory in correction device 8 is then subtracted from the humidity value measured by humidity sensor 1 in a subtraction unit 11 and a corrected measured value is output via a display 17 in subsequent humidity measurements.

FIG. 2 shows schematically the detection and computation steps in a calibration operation. In a first step, humidity value U1 is detected by humidity sensor 1 and stored in a first data memory 12.

In a second step, a second humidity value U2 is then measured at the second pressure value and otherwise identical ambient conditions and saved.

Ratio P1/P2 is calculated in advance and saved in a data memory 14. In a computation unit 15, k is then calculated using the equation given above and forwarded to an output device 16 which sends the correction value to correction device 8, for example, where it is stored in memory 10.

FIG. 3 shows the calibration operation again in the form of flow steps in a flow chart. In a first step 101, a certain pressure is set in the measuring chamber via the first flow resistance. In second step 102, humidity value U1 is measured.

In third step 103, the pressure in the measuring chamber is altered to a second value by setting a second flow resistance in the first gas connection.

In fourth step 104, a second humidity value U2 is measured. The quotient of U1 and U2 is calculated in fifth step 105. Quotients of P1 and P2 as well as U1 and U2 are compared in sixth step 106. If the two quotients agree, then correction value k=0 is set in a next step (109) and the calibration operation is terminated. If the quotients do not match, then in next step 107, k is calculated from the equation given above. In eighth step 108, k is then stored in memory 10 for correction of the following humidity measurements.

FIG. 4 shows in detail the calibration device having a measuring chamber 2 which has a first gas connection 3 and a second gas connection 4, first gas connection 3 being connected to a gas-pressurizable unit 5 and having a first inflow channel 3a and a second inflow channel 3b in the form of a gas pipe. First inflow channel 3a has a constriction 3d having an enlarged first flow resistance.

In the first state, second inflow channel 3b is cut off by ball valve 3c, represented symbolically by a bold line, and is opened in a second state so that it bridges first inflow channel 3a.

In the opened state of ball valve 3c, approximately the same pressure prevails in measuring chamber 2 as in unit 5 because gas cannot flow out through second gas connection 4 as quickly as gas flows in through first gas connection 3. Gas connection 4 leads to the outside, i.e., is connected to atmospheric pressure on the secondary side. It has a constriction 4a which has a third flow resistance.

If ball valve 3c is closed, gas flows out of unit 5 into the measuring chamber only through constriction 3d; thereby establishing an intermediate pressure in measuring chamber 2 based on the ratio of flow resistances of constrictions 3d, 4a. The two aforementioned pressure values are highly reproducible and their ratio is reproducibly fixed and measured. The quotient is stored in memory 14 from FIG. 2.

In a calibration example, a first pressure value P1=4.5 bar was set first. At this pressure value, a humidity value U1=1.7% relative humidity was measured by using the humidity sensor. A humidity value of 0.5% relative humidity was measured at a second gas pressure of 0.9 bar after opening the ball valve. The quotient of the pressure values was 5.

The relative humidity value at a high pressure would thus have to drop from 1.7% relative humidity to 0.34% relative humidity at the lower pressure value. However, a value of 0.5% relative humidity was measured at the lower pressure value. This means that a correction is necessary, and k is obtained as follows

k=(5*0.5% rel. hum.−1.7% rel. hum.)/(5−1)=0.2% rel. hum.

Corrected humidity values according to the measurement performed are thus U1 (real)=1.7% rel. hum.−0.2% rel. hum.=1.5% rel. hum. and

U2(real)=0.5% rel. hum.−0.2% rel. hum.=0.3% rel. hum.

The calibration method described here may be performed cyclically, i.e., periodically during operation of the humidity sensor and a new correction value may be calculated and stored each time.

1. A device for calibrating a humidity sensor, comprising;
a measuring chamber which has a first gas connection for connecting to a pressurizable unit and a second gas connection for connecting to another gas space, wherein at least one of the first and the second gas connection has a flow resistance adjustable to two different fixed values.

2. The device as recited in claim 1, wherein at least one of the first gas connection and the second gas connection has a first channel having a first flow resistance and a second channel having a second flow resistance running in parallel to the first channel, wherein the at least one of the first gas connection and the second gas connection is closable with a cutoff device and bridges the first channel in the opened state of the cutoff device.

3. The device as recited in claim 2, wherein the second gas connection has a single channel having a flow resistance greater than the flow resistances of the first and second channels of the first gas connection.

4. The device as recited in claim 2, wherein a ratio of the flow resistance of the second gas connection to the flow resistance of the second channel of the first gas connection is greater than 10:1.

5. The device as recited in claim 2, wherein the flow resistance of the second gas connection is less than the flow resistance of the first channel of the first gas connection.

6. The device according to claim 2, wherein the second channel of the first or second gas connection is formed by a gas pipe which can be cut off via a ball valve.

7. A sensor system for measuring a gas humidity content, comprising:
a humidity sensor; and
a device for calibrating the humidity sensor, wherein the device includes a measuring chamber which has a first gas connection for connecting to a pressurizable unit and a second gas connection for connecting to another gas space, and wherein at least one of the first and the second gas connection has a flow resistance adjustable to two different fixed values.

8. The system as recited in claim 7, wherein at least one of the first gas connection and the second gas connection has a first channel having a first flow resistance and a second channel having a second flow resistance running in parallel to the first channel, wherein the at least one of the first gas connection and the second gas connection is closable with a cutoff device and bridges the first channel in the opened state of the cutoff device.

9. The system as recited in claim 8, wherein the second gas connection has a single channel having a flow resistance greater than the flow resistances of the first and second channels of the first gas connection.

10. The system as recited in claim 8, wherein a ratio of the flow resistance of the second gas connection to the flow resistance of the second channel of the first gas connection is greater than 10:1.

11. The system as recited in claim 8, wherein the flow resistance of the second gas connection is less than the flow resistance of the first channel of the first gas connection.

12. The system according to claim 8, wherein the second channel of the first or second gas connection is formed by a gas pipe which can be cut off via a ball valve.

13. A method for calibrating a humidity sensor, comprising:
providing a measuring chamber having a first gas connection for connecting to a pressurizable unit and a second gas connection for connecting to another gas space;
disposing the humidity sensor in the measuring chamber, wherein at least one of the first and second gas connections has a flow resistance adjustable to two different fixed values;
setting a pressure in the measuring chamber via the first flow resistance in the first gas connection;
measuring a first humidity value;
changing the pressure in the measuring chamber by setting a second flow resistance in the first gas connection to a second value;
measuring a second humidity value;
calculating the quotient from U1 and U2;
comparing the quotients of P1 and P2 as well as U1 and U2;
setting a correction value to 0 if the two quotients match;
calculating the correction value with the help of the equation:
k=((P1/P2)*U2−U1)/(P1/P2−1), if the two quotients do not match; and
saving the correction value in a memory.

14. The method as recited in claim 13, wherein, for calibrating the humidity sensor, first the measuring chamber is connected via the first gas connection to the pressurizable unit so that gas flows in through a first channel and flows out of the measuring chamber again through the second gas connection, the first humidity value being determined at the first pressure value which is set based on the ratio of the flow resistances, wherein the flow resistance of the first gas connection is changed to a second value by opening a ball valve in a second channel of the gas connection, so that a second pressure value at which the second humidity value is measured is established in the measuring chamber.

15. The method as recited in claim 13, wherein at least one of the first gas connection and the second gas connection has a first channel having a first flow resistance and a second channel having a second flow resistance running in parallel to the first channel, wherein the at least one of the first gas connection and the second gas connection is closable with a cutoff device and-bridges the first channel in the opened state of the cutoff device.

16. The method as recited in claim 15, wherein the second gas connection has a single channel having a flow resistance greater than the flow resistances of the first and second channels of the first gas connection.

17. The method as recited in claim 15, wherein a ratio of the flow resistance of the second gas connection to the flow resistance of the second channel of the first gas connection is greater than 10:1.

18. The method as recited in claim 15, wherein the flow resistance of the second gas connection is less than the flow resistance of the first channel of the first gas connection.

19. The method according to claim 15, wherein the second channel of the first or second gas connection is formed by a gas pipe which can be cut off via a ball valve.
